(19) United States
(12) Patent Application Publication
(10) Pub. No.: US 2006/0243214 A1
(43) Pub. Date: Nov. 2, 2006

(54) Terrarium lighting fixture

(75) Inventor: Emmanuel Van Heygen, Mechelen (BE)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Rolf C. Hagen, Inc., Montreal (CA)

(21) Appl. No.: 11/116,818

(22) Filed: Apr. 28, 2005

(51) Int. Cl. A01K 63/06

(52) U.S. Cl. 119/267

(57) ABSTRACT

A light assembly for enclosed animal habitats, such as terrariums and aquariums, is provided. The assembly includes a light source, and a reflective luminous surface arranged with respect to the light source to absorb energy from the light source while the light source is turned on, and to emit the stored light for a finite period of time after the light source is turned off. The light assembly is designed to simulate natural light. In one embodiment, the light assembly includes a fixture that generally resembles a conventional light fixture with a reflector, socket and power source connection, with the reflector having a highly reflective, luminous coating that continues to glow to direct light and/or heat to the interior of the habitat after the lamp or heater is turned off.

### FIELD OF INVENTION

This invention relates to the lighting of animal enclosures, such as terrariums and aquariums, and more particularly relates to a device that gradually reduces the light and/or heat directed to the animal's habitat after the active source of light or heat has been turned off.

### BACKGROUND OF INVENTION

Presently, animal habitats, such as terrariums and aquariums, are customarily lighted by either incandescent or florescent lights that are manually controlled by on-off switches that cause the habitat to either be fully illuminated or dark. Unlike what occurs naturally as day changes to night, when a conventional light is turned off, the habitat is immediately darkened. Similarly, heaters used for animal habitats are essentially on-off devices that do not gradually allow the temperature to change.

### SUMMARY OF INVENTION

In accordance with one aspect of the present invention, a light assembly for use with a terrarium is provided. The light assembly includes a light source, means for connecting the light source to a power source, and a reflective, luminous surface. The luminous surface is operatively arranged with respect to the light source to reflect light from the light source into the terrarium when the light source is connected to the power source, and the reflective luminous surface continues to glow for a finite period of time after the light source is disconnected from the power source.

In accordance with another aspect of the invention, a light fixture for use with a terrarium is provided. The light fixture includes a light socket carrying a lamp and means for connecting the socket to a power source, a shade at least partially surrounding the lamp, and means for supporting the socket with respect to the terrarium so as to direct light into the terrarium. The shade has a reflective, luminous surface for directing light from the lamp into the terrarium that continues to glow after the lamp is disconnected from the power source.

In yet another embodiment, a reptile habitat is provided. The reptile habitat includes a terrarium, and a light assembly positioned in operative relation to the terrarium to direct light into the interior of the terrarium. The light assembly includes a lamp and a reflector for directing light from the lamp into the terrarium. The reflector includes a reflective, luminous coating for directing a constant intensity of light into the terrarium when the lamp is energized and directing a gradually diminishing amount of light to the terrarium for a finite period after termination of energy to the lamp.

In another embodiment, a reptile habitat is provided. The reptile habitat includes a terrarium, and a light assembly in operative relation to the terrarium for directing light into the interior of the terrarium. The light assembly includes a light source for directing a uniform level of light to the terrarium for a first indefinite period of time and a gradually and continuously diminishing level of light for a second finite period of time.

In yet another embodiment, a reptile light fixture for use with a terrarium is provided. The light fixture includes a light source having a lamp for directing a uniform level of light to the terrarium for a first indefinite period of time while the lamp is energized and a constantly diminishing level of light for a second finite period of time after the lamp is de-energized.

### DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a terrarium on which is mounted a light source in accordance with one embodiment of the present invention;

FIG. 2 is a cross-sectional view of another terrarium having the light source mounted in another embodiment of the present invention; and

FIG. 3 is a graph plotting the light intensity of one embodiment of the present invention when the light is on and also showing its intensity for a period after the power has been turned off.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

The present invention is directed to a light assembly for use with an animal habitat that, in one embodiment, directs a uniform level of light for a first indefinite period of time when the light assembly is connected to a power source and thereafter a gradually and continuously diminishing level of light for a second finite period of time once the light assembly is turned off and disconnected to a power source. This type of light assembly more accurately imitates natural light when the sun sets, and in some embodiments, the low light level provides a night glow light.

As described in further detail below, in one embodiment of the present invention, the light assembly includes a reflective luminous material. When the light source is turned on, the reflective luminous material absorbs energy from the light source. Once the light source is turned off, the luminous material emits the stored energy in the form of a glowing light. In one embodiment, the light emitted from the luminous material gradually diminishes over the course of a couple of hours, which simulates the sun setting in a natural environment. In one embodiment, the luminous material may be in the form of a coating.

In accordance with one aspect of the present invention, the light and/or heat source is disconnected instantaneously from the power source but the level of light or the degree of heat gradually diminishes over a matter of minutes or even hours until the lighting and/or heating is finally fully terminated. In this fashion, the changes in light and temperature imitates what occurs naturally.

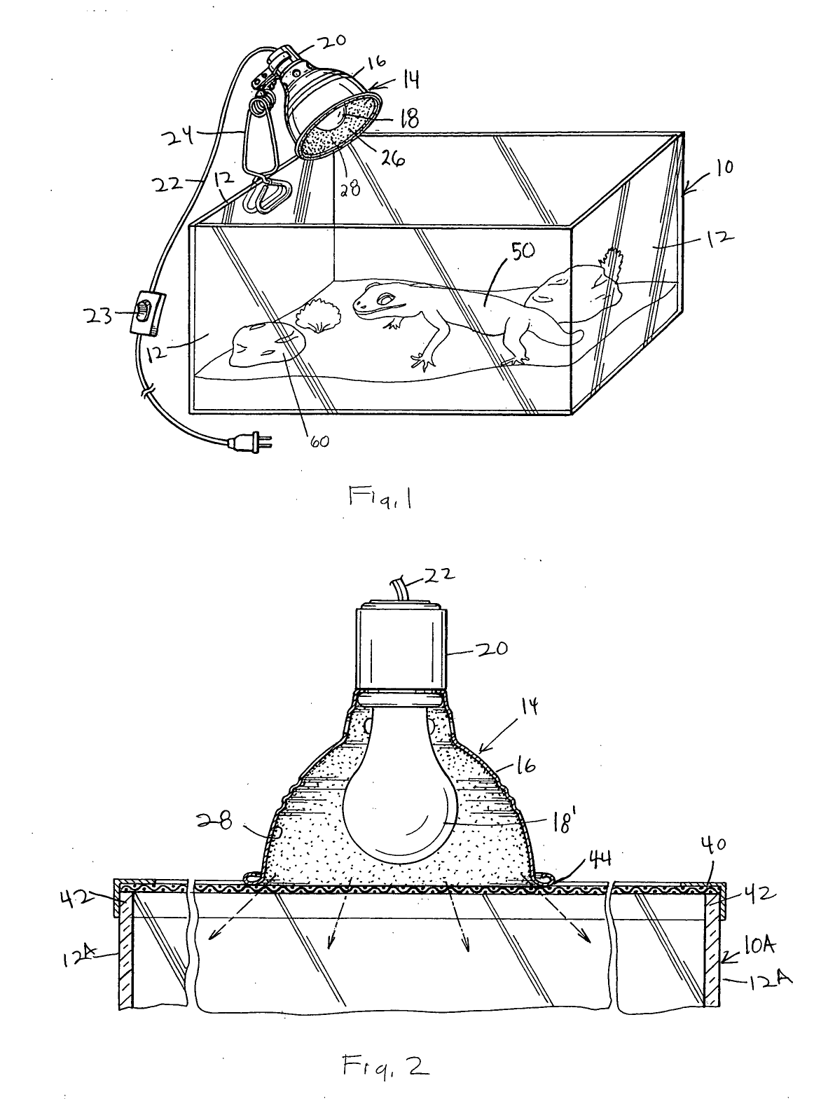

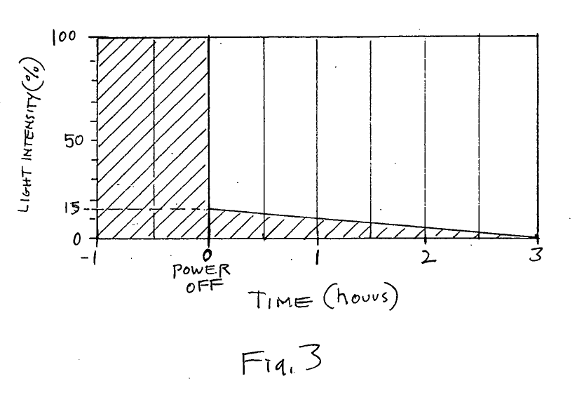

In FIGS. 1 and 2, typical terrariums are suggested at 10 and 10A that generically represent a typical habitat for animals such as reptiles 50 or fish (not shown). Some reptiles that may commonly be housed in terrariums include snakes, lizards, crocodiles, turtles, and alligators. FIG. 1 shows the terrarium having earth, rocks and vegetation, all or part of which may be artificial. At least some of the vertical walls 12 of the terrarium are transparent, being made of glass, clear plastic, or some similar material that is nontoxic and possesses sufficient strength to function in the setting prescribed. The transparent walls enable animals in the terrarium to be easily viewed. The terrarium may also include a cover 40 (see FIG. 2) which may have openings therein to enable air to circulate through the terrarium interior and the cover 40 may also be transparent like the side walls 12 to facilitate viewing of the animals inside.

A fixture 14 shown in alternative positions in FIGS. 1 and 2 supplies light and/or heat to the terrarium when turned on and also gradually diminishes the level of light and/or heat directed to the terrarium interior after the fixture is turned off. The fixture 14 may have the general appearance of a conventional light fixture and may include a reflector or shade 16, a bulb 18 and/or heat source 18′, a socket 20, and power cord 22 with an on-off switch 23. The fixture may also include a clamp assembly 24 which may be used to attach the fixture 14 to the terrarium structure, such as the wall 12 as shown in FIG. 1. As described more fully below, the inside surface 26 of the fixture 14 carries a highly reflective, luminous coating 28.

Typically, the bulb 18 may be a conventional incandescent lamp and its wattage may vary depending upon the size of the fixture and terrarium to be illuminated by it. However, in other embodiments, fluorescent bulbs may alternatively be used as the light source. It should be appreciated that the light source may be any type of conventional light source, such as incandescent or fluorescent, as the present invention is not limited in this respect. In one particular embodiment, the socket is made of a heat resistance porcelain material, and is rated for a 150 watt incandescent light bulb.

The coating 28 serves as a light and/or heat source for the terrarium after the light and/or heat source is switched off. The graph shown in FIG. 3 illustrates the light intensity directed to the terrarium for a period in which the power to the lamp is on and also shows that the light intensity diminishes gradually after the power is turned off. In one embodiment of the present invention as depicted in FIG. 3, the light intensity may diminish immediately upon switching the power off to a value approximately 15% of the light intensity while the power is on. In this embodiment, for a period of about 15 minutes, the intensity remains at a constant reduced intensity and then gradually diminishes to zero over the next couple of hours. However, in another embodiment, the light intensity may immediately diminish to about between 5%-20% of the light intensity while the power is on. Similarly, in one embodiment, the light intensity may gradually diminish to zero over about one hour or up to five hours. These periods of time may vary depending upon the wattage of the bulb 18 and upon ambient temperatures, and may also vary based upon the area and thickness of the luminous coating 28.

In some embodiments, the light assembly emits heat as well as light. In these embodiments, the luminous coating may also function to emit energy in the form of heat once the light is turned off. It should be appreciated that some lights have a tendency to emit more heat than others. Accordingly, when the light emits heat, the energy absorbing/emitting material may also absorb and emit heat after the light is turned off. In some embodiments, a ceramic heat emitter is used.

Various types of luminous coatings may be implemented into the present invention. For example, in one embodiment, a phosphorescent pigment may be used as the luminous coating. The phosphorescent pigment absorbs energy from various kinds of visible light, stores the light energy, and then emits the light energy for a period of time. One type of phosphorous pigment is NCC-NL, which has the chemical identity of SrAl₂O₄:EuDy which has an afterglow persistence of approximately 7 hours. Another type of phosphorous pigment is ZnS:Cu which has an afterglow persistence of approximately 30 minutes. It should be appreciated that any type of luminous coating may be used, as the present invention is not limited in this respect.

In the embodiment of FIG. 2, the terrarium cover 40 is removably mounted on the tops of the side walls 12A. In this embodiment, the fixture 14 is disposed directly on the cover 40 positioned with a reflector rim 44 resting on the cover. When mounted in that manner, the clamp 24 is not utilized and may be separated from the fixture. When mounted in that fashion, the level of light introduced to the interior of the terrarium may be somewhat greater than that delivered by the fixture mounted as in FIG. 1.

It should be appreciated that the present invention may be used with any type of structure used as an animal habitat, such as a terrarium, aquarium, vivarium, etc. However, for simplicity, particularly in the claims, Applicant has broadly used the term “terrarium” to encompass all of the structures that could be used to hold and enclose various types of animals.

In one embodiment, portions of the assembly may be positioned inside of the terrarium. For example, a structure within the terrarium may include at least a portion of the reflective luminous surface. In one embodiment, the rock-like structure 60 illustrated in FIG. 1 is coated with a reflective luminous coating 28. As described above, the luminous coating absorbs energy when the light source is directing light at the rock-like structure 60. Once the light source is turned off, the rock-like structure 60 then glows as it emits light back into the terrarium for a period of time. It should be appreciated that the structure inside of the terrarium coated with a luminous material may be used in conjunction with the above-described reflector or shade 16, or alternatively, in other embodiments, the luminous coated structure may be the only luminous surface. In some embodiments, the light source may also be contained inside of the terrarium, as the present invention is not so limited.

It should also be recognized that various types of power sources may be used to illuminate the light source, as the present invention is not limited in this respect. As described above, the light source may be plugged into a conventional outlet. Alternatively, the light source may be battery powered.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A light assembly for use with a terrarium, comprising:
a light source and means for connecting the light source to a power source; and
a reflective, luminous surface operatively arranged with respect to the light source to reflect light from the light source into the terrarium when the light source is connected to the power source; and
wherein the reflective luminous surface continues to glow for a finite period of time after the light source is disconnected from the power source.

2. The light assembly of claim 1, further comprising a shade at least partially surrounding the light source, wherein the shade includes at least a portion of the reflective luminous surface.

3. The light assembly of claim 2, wherein the shade is connected to the light source.

4. The light assembly of claim 1, further comprising a clamp for securing the light source to a terrarium.

5. The light assembly of claim 1, in combination with a terrarium.

6. The light assembly of claim 5, wherein at least a portion of the reflective luminous surface is positioned within the terrarium.

7. The light assembly of claim 6, further comprising a structure within the terrarium, wherein the structure includes at least a portion of the reflective luminous surface.

8. The light assembly of claim 7, wherein the structure is constructed and arranged to have the appearance of a rock-like structure.

9. A light fixture for use with a terrarium, comprising:
a light socket carrying a lamp and means for connecting the socket to a power source;
a shade at least partially surrounding the lamp, the shade having a reflective, luminous surface for directing light from the lamp into the terrarium that continues to glow after the lamp is disconnected from the power source; and
means for supporting the socket with respect to the terrarium so as to direct light into the terrarium.

10. The light fixture of claim 9, wherein the shade is connected to the light socket.

11. The light fixture of claim 9, wherein the means for supporting the socket is a clamp for engaging a wall of the terrarium.

12. The light fixture of claim 9, wherein the means for supporting the socket is a rim extending at least partially about the shade.

13. The reptile habitat of claim 9, wherein the luminous surface on the shade is capable of directing a diminishing amount of light for at least 1 hour after the lamp is disconnected from the power source.

14. A reptile habitat comprising:
a terrarium;
a light assembly positioned in operative relation to the terrarium to direct light into the interior thereof;
said light assembly including a lamp, and a reflector for directing light from the lamp into the terrarium; and
a reflective, luminous coating on the reflector for directing a constant intensity of light into the terrarium when the lamp is energized and for directing a gradually diminishing amount of light in the terrarium for a finite period after termination of energy to the lamp.

15. The reptile habitat of claim 14, wherein the reflector is positioned within the terrarium.

16. The retile habitat of claim 14, wherein the reflector is connected to the lamp.

17. The reptile habitat of claim 16, further comprising means for mounting the light assembly on the terrarium.

18. The reptile habitat of claim 16, wherein the reflector has a portion capable of functioning as a stand for supporting the light assembly on a surface of the terrarium.

19. The reptile habitat of claim 14, wherein the luminous coating on the reflector is capable of directing a diminishing amount of light into the terrarium for at least 1 hour after the termination of the energy to the lamp.

20. The reptile habitat of claim 14, wherein the luminous coating on the reflector is capable of directing a diminishing amount of light into the terrarium for up to five hours after the termination of the energy to the lamp.

21. The reptile habitat of claim 17, wherein the means for mounting is a clamp for engaging a wall of a terrarium.

22. A reptile habitat comprising:
a terrarium;
a light assembly in operative relation to the terrarium for directing light into the interior thereof,
said light assembly including a light source for directing a uniform level of light to the terrarium for a first indefinite period of time and a gradually and continuously diminishing level of light for a second finite period of time.

23. The reptile habitat as defined in claim 22, further comprising a support for securing the light assembly on the terrarium.

24. The reptile habitat as defined in claim 23, wherein the support includes a clamp for engaging a portion of the terrarium.

25. A reptile light fixture for use with a terrarium, comprising:
a light source having a lamp for directing a uniform level of light to the terrarium for a first indefinite period of time while the lamp is energized and a constantly diminishing level of light for a second finite period of time after the lamp is de-energized.

26. The reptile light fixture as defined in claim 25, wherein the second finite period of time is at least one hour.
